(19) United States
(12) Patent Application Publication
(10) Pub. No.: US 2019/0369828 A1
(43) Pub. Date: Dec. 5, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Tomoki KITAHASHI, Kanagawa (JP)

(73) Assignee: FUJI XEROX CO., LTD., Tokyo (JP)

(21) Appl. No.: 16/420,424

(22) Filed: May 23, 2019

(30) Foreign Application Priority Data
May 30, 2018 (JP) 2018-103726
May 30, 2018 (JP) 2018-103727

(51) Int. Cl. G06F 3/0487; G06F 3/0484; G06F 3/16

(52) U.S. Cl. CPC G06F 3/0487; G06F 3/16; G06F 3/0484

(57) ABSTRACT

There is provided an information processing apparatus including a creator and a granting unit. The creator is configured to create a second talk group based on a first talk group on a service on which massage talks are exchanged between plural users. The first talk group consists of a first user group. The second talk group consists of a second user group including one or more users of the first user group. The second user group is different from the first user group. The granting unit is configured to, when the second talk group is created, give to users of the second user group, access authority to access a predetermined range of message talks in the first talk group.

### CROSS-REFERENCE TO RELATED APPLICATIONS

This application is based on and claims priority under 35 USC 119 from Japanese Patent Application No. 2018-103726 and Japanese Patent Application No. 2018-103727 both filed May 30, 2018.

### BACKGROUND

### (i) Technical Field

The present disclosure relates to an information processing apparatus and a non-transitory computer readable medium.

### (ii) Related Art

JP-A-2006-350628 discloses a scheme of enhancing the convenience of mutual exchange of information about, for example, a chat room between users while allowing the users to freely create, for example, an additional chat room in a communication system such as a chat room system or a bulletin board system in which plural users may participate. When a user is accessing plural chat rooms, the scheme causes the user to select at least one chat room from the plural chat rooms and displays address information of the selected active room on a room link display unit. The user may transfer the address information of the active room to a user of another chat room by copying the address information to a message area and delivering the address information to the chat room that the user is accessing.

JP-A-2002-108792 discloses a scheme of enabling a reference to the past message contents, allowing a person who has not participated in a chat to refer to the message contents at a later time so that a user who have entered the chat room later may refer to the speech contents, and preventing an unrelated user from referring to the message contents. The scheme sets access authority to all clients who have entered the chat room and also sets access authority to a client outside the chat room based on the approval of some or all of the clients who has entered the chat room. Only the persons who possess the access authority may access the past message contents stored in a message content storage area. All of the other participants are notified that reference is made to the past message contents.

### BRIEF DESCRIPTION OF THE DRAWINGS

Exemplary embodiment(s) of the present disclosure will be described in detail based on the following figures, wherein:

FIG. 1 is a diagram illustrating the configuration of a system according to an exemplary embodiment;

FIG. 2 is a functional block diagram of a chat service server according to the exemplary embodiment;

FIG. 3 is a block diagram illustrating the configuration of the chat service server according to the exemplary embodiment;

FIG. 4 is a functional block diagram of a user terminal according to the exemplary embodiment;

FIG. 5A is an explanatory diagram of a talk group according to the exemplary embodiment;

FIG. 5B is an explanatory diagram of another talk group according to the exemplary embodiment;

FIG. 6 is an explanatory diagram (part 1) of a screen displayed on the user terminal according to the exemplary embodiment;

FIG. 7 is an explanatory diagram (part 2) of the screen displayed on the user terminal according to the exemplary embodiment;

FIG. 8 is an explanatory diagram (part 3) of the screen displayed on the user terminal according to the exemplary embodiment;

FIG. 9 is an explanatory diagram (part 4) of the screen displayed on the user terminal according to the exemplary embodiment;

FIG. 10 is an explanatory diagram (part 5) of the screen displayed on the user terminal according to the exemplary embodiment;

FIG. 11 is an explanatory view of another screen displayed on the user terminal according to the exemplary embodiment;

FIG. 12 is an explanatory diagram (part 1) of a further another screen displayed on the user terminal according to the exemplary embodiment;

FIG. 13 is an explanatory diagram (part 2) of the further other screen displayed on the user terminal according to the exemplary embodiment;

FIG. 14 is an explanatory diagram (part 3) of the further other screen displayed on the user terminal according to the exemplary embodiment;

FIG. 15 is an explanatory diagram (part 4) of the further other screen displayed on the user terminal according to the exemplary embodiment;

FIG. 16 is an explanatory diagram of a talk group list screen displayed on the user terminal according to the exemplary embodiment;

FIG. 17 is an explanatory diagram of a talk group list screen displayed on another user terminal according to the exemplary embodiment;

FIGS. 18A and 18B are explanatory views of screen transition according to the exemplary embodiment;

FIG. 19 is a sequence diagram according to the exemplary embodiment;

FIG. 20 is another sequence diagram according to the exemplary embodiment;

FIG. 21 is an explanatory diagram of a screen according to a modification;

FIG. 22 is an explanatory diagram of a screen according to another modification; and

FIG. 23 is an explanatory diagram of another screen.

### DETAILED DESCRIPTION

Hereinafter, exemplary embodiments of the present disclosure will be described with reference to the accompanying drawings.

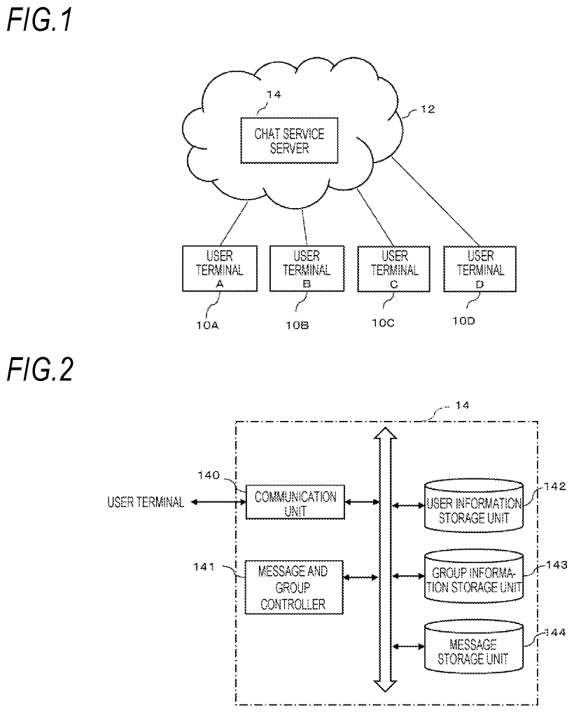

FIG. 1 is a diagram illustrating the overall configuration of a messaging service system according to an exemplary embodiment. The messaging service system includes user terminals A (10A) to D (10D) and a chat service server 14.

The user terminals A (10A) to D (10D) are terminals used by users of a messaging service. The user terminals A (10A) to D (10D) are information terminals such as a smart phone, a tablet terminal, and a personal computer (PC). In FIG. 1, four terminals including the user terminal A (10A), the user terminal B (10B), the user terminal C (10C), and the user terminal D (10D) are illustrated. It should be noted that the number of terminals may be any number. Plural users access the chat service server 14 on a cloud 12 by operating the user terminals A (10A) to D (10D), respectively, and chat with other users by exchanging messages. Hereinafter, it is assumed that a user A operates the user terminal A, a user B operates the user terminal B, a user C operates the user terminal C, and a user D operates the user terminal D. The user terminals A (10A) to D (10D) and the chat service server 14 are connected so as to enable data transmission and reception via a wired or wireless communication network. An example of the communication network is a public line such as the Internet. Alternatively, the communication network may be a dedicated line.

The chat service server 14 is a cloud server provided on the cloud 12 and is a server that provides a chat service. The chat service server 14 is implemented by one or more server computers. The chat service server 14 executes all processes related to exchange of message talk such as a process of transmitting and receiving message talks for the user terminals A to D and displaying of the transmission and reception of the message talks on a display screen. In addition to processing exchange of message talks between two users, the chat service server 14 may create a group including three or more users (which may be referred to as a “talk group”) and process exchange of message talks within the group (which may be referred to as “group chat”). Here, the term “message talk” refers to data such as texts, images, and moving images. Information may be shared by exchange of the data between plural persons.

FIG. 2 is a functional block diagram of the chat service server 14. The chat service server 14 includes, as functional blocks, a communication unit 140, a message and group controller 141, a user information storage unit 142, a group information storage unit 143, and a message storage unit 144.

The communication unit 140 communicates with the user terminals A to D and exchanges messages between the user terminals A to D. For example, the communication unit 140 receives a message transmitted from the user terminal A, transmits the message to the user terminal B, receives a message transmitted from the user terminal B, and transmits the message to the user terminal A, thereby establishing a talk between the user terminal A and the user terminal B.

The message and group controller 141 controls transmission and reception of messages to and from the user terminals A to D. In addition, the message and group controller 141 controls creation and deletion of a talk group. The creation of the talk group includes creation of a new talk group separately from an existing talk group and derivation of another talk group from an existing talk group. An example of the derivation of another talk group is as follows. That is, the user A, the user B, and the user C already form one talk group to exchange message talks, and for a theme related to a talk theme of this group, a new user D is added so that the user A, the user B, the user C, and the user D form another talk group. In this case, the original talk group may be referred to as a “derivation source talk group”, and the derived talk group may be referred to as a “derivative talk group”. The derivative talk group includes one or more users of the derivation source talk group. A user group of the derivative talk group is different from that of the derivation source talk group.

The user information storage unit 142 stores information on users who use the chat service. The user information is, for example, a user ID or a password. It should be noted that the user information is not limited to these examples.

The group information storage unit 143 stores information on a created talk group. Examples of the information on the talk group include a name of the talk group, users of the talk group (members of the talk group), and access authority of the users. It should be noted that the information on the talk group is not limited to these examples.

The message storage unit 144 stores a message group received from the user terminals A to D. The message storage unit 144 stores, in particular, message talks exchanged in a talk group, for each talk group.

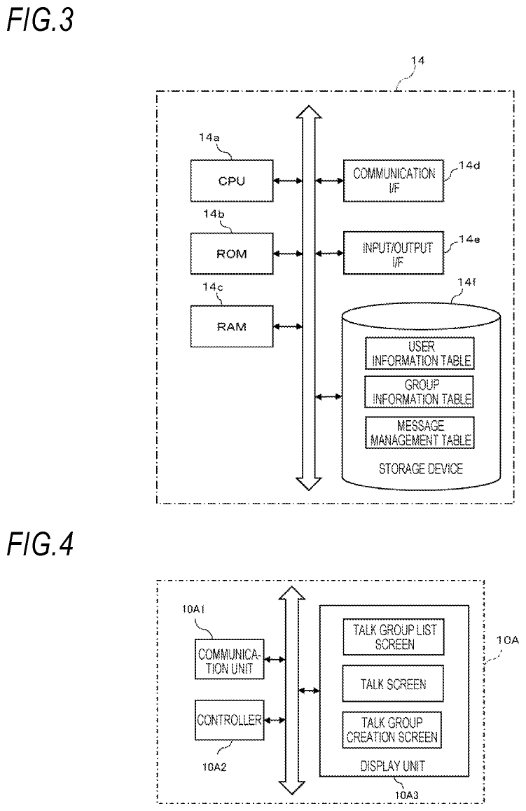

FIG. 3 is a block diagram illustrating the configuration of the chat service server 14. The chat service server 14 includes, as constituent blocks, one or more CPUs 14a, a ROM 14b, a RAM 14c, a communication interface (I/F) 14d, an input/output I/F 14e, and a storage device 14f.

The one or more CPUs 14a implement the functions of the chat service server by reading a processing program stored in the ROM 14b or the storage device 14f and using the RAM 14c as a working memory. That is, the CPUs 14a transmit and receive message talks between the user terminals A to D and execute the creation and deletion of a talk group between the user terminals A to D. The creation of the talk group includes a user interface (UI) for creating a talk group. The CPUs 14a implement the message and group controller 141 illustrated in FIG. 2.

The communication I/F 14d communicates with the user terminals A to D.

The input/output I/F 14e receives data from an input device such as a keyboard or a mouse and transmits data to an output device such as a display device.

The storage device 14f is configured with a nonvolatile memory such as a hard disk drive (HDD) or a solid state drive (SSD). The storage device 14f stores a user information table, a group information table, and a message management table, in addition to storing the processing program. The storage device 14f implements the user information storage unit 142, the group information storage unit 143, and the message storage unit 144 illustrated in FIG. 2.

In addition, in the present exemplary embodiment, the processing program for implementing the chat service is executed by the CPUs 14a. A part of the chat service may be implemented by a hardware processing instead of a process by the execution of the program. The hardware processing may be performed using a circuit such as an ASIC or a field programmable gate array (FPGA).

FIG. 4 is a functional block diagram of the user terminal A as a representative example of the user terminals A to D. The other user terminals B, C, and D have the same functional blocks. The user terminal A includes, as functional blocks, a communication unit 10A1, a controller 10A2, and a display unit 10A3. In addition, the user terminal A includes a user operable input device such as a mouse or a keyboard. It should be noted that illustrations thereof are omitted in the figures.

The communication unit 10A1 transmits and receives message talks and various data to and from the chat service server 14 on the cloud 12.

The controller 10A2 includes one or more CPUs. The controller 10A2 reads out and executes a processing program to control an operation of each unit. In particular, the controller 10A2 displays various screens related to a talk group on the display unit 10A3 in response to a mouse or keyboard operation by the user A or a touch operation on a touch panel by the user A. The controller 10A2 sets access authority upon reception of various information about a derivative talk group on a talk group creation screen.

The display unit 10A3 is configured with a liquid crystal display or an organic EL display. The display unit 10A3 displays a message talk that is transmitted and received under the control of the controller 10A2. The display unit 10A3 displays, as display screens, a talk group list screen, a talk screen, and the talk group creation screen. The talk group list screen is a screen that displays a list of created talk groups in a list format. The talk screen is a screen that displays message talk contents in a talk group from top to bottom in the chronological order. The talk group creation screen is a screen that is displayed when a new talk group is created. The controller 10A2 displays the talk group list screen, the talk screen, and the talk group creation screen on the display unit 10A3 in response to an operation by the user A.

Each of the talk group list screen, the talk screen, and the talk group creation screen is created by the controller 10A2 reading out and executing an application program (client application) stored in a program memory of the user terminal A (for example, a ROM, an HDD, or an SDD) and is displayed on the display unit 10A3. Alternatively, the chat service server 14 may create these screens and display the screens on the display unit 10A3 with Web client software of the user terminal A. In the latter case, the message and group controller 141 of the chat service server 14 creates each of the talk group list screen, the talk screen, and the talk group creation screen in response to a request from the user terminal A and sends back the created talk group creation screen to the user terminal A. The controller 10A2 displays the talk group list screen on the display unit 10A3 and switches the talk group list screen to the talk group creation screen for display, in response to an operation by the user A. Alternatively, the controller 10A2 displays the talk screen on the display unit 10A3 and switches the talk screen to the talk group creation screen for display, in response to an operation by the user A. The user A creates another talk group (second talk group) based on a talk group (first talk group) using the talk group creation screen.

In a case where the user terminal A creates and displays each of the talk group list screen, the talk screen, and the talk group creation screen, the user terminal A serves as an information processing apparatus and the controller 10A2 of the user terminal A serves as a creator configured to create the second talk group based on the first talk group and a granting unit configured to access authority.

In addition, in a case where the chat service server 14 creates each of the talk group list screen, the talk screen, and the talk group creation screen and displays the created screens on the user terminal A, the chat service server 14 serves as an information processing apparatus and the message and group controller 141 of the chat service server 14 serves as a creator configured to create the second talk group based on the first talk group and a granting unit configured to give access authority.

Hereinafter, a process of creating the talk group will be described in detail.

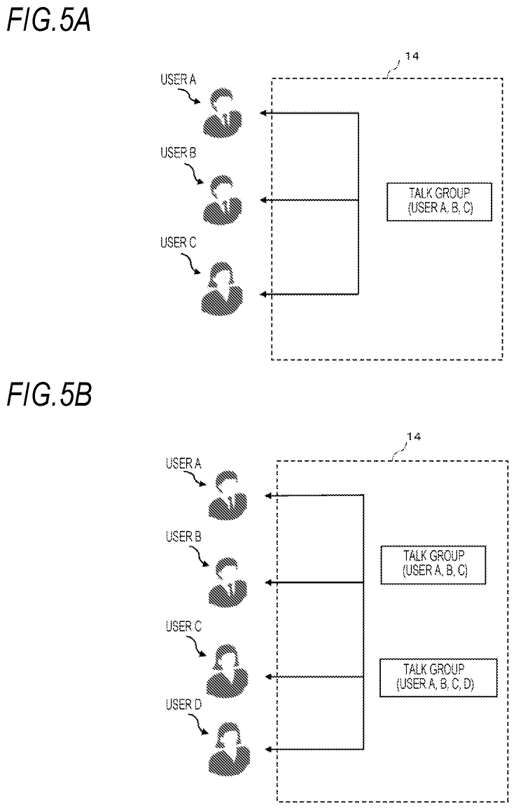

FIG. 5A schematically illustrates a state where the users A, B, and C form a talk group and perform a group chat using a chat service implemented by the chat service server 14. For example, it is assumed that the users A, B, and C are employees of a software development company, develop software on contract basis, and are jointly developing software for an X company which is a client company, and that the users A, B, and C form a talk group named “X Company Project Development” (first talk group) and exchange message talks and documents.

As the development of an X company project progresses, the users A to C realize that it is difficult to implement a predetermined function Y and repeatedly discuss this matter within the talk group “X Company Project Development”. During the discussion, with regard to the implementation of the function Y, the users A to C decide to make further discussion with the user D who does not handle X company projects but has knowledge about a function similar to the function Y. In addition, the number of message talks about the function Y in the talk group excessively increases, which makes it difficult to view discussions about other issues.

In such a case, the user A creates a new talk group about the function Y by deriving such a new talk group from the talk group “X Company Project Development”, and includes the user D in the derivative talk group (second talk group).

FIG. 5B schematically illustrates a state where, by newly adding the user D, the users A to D form the new talk group (second talk group) and perform a group chat. In addition to the talk group “X Company Project Development”, the users A to D form a new talk group named “Consideration of Implementation of Function Y in X Company Project” and exchange message talks and documents.

Here, if the newly added user D is able to view message talk content of a derivation source talk group, that is, message talk contents in the talk group “X Company Project Development” without any limitation, a security problem might occur. The user D is not a member of “X Company Project Development”. If the user D knows message talk contents therein, doubt on confidentiality obligation might arise and the significance of limiting members would be lost. In the meantime, if the user D is not able to view the message talk contents of the derivation source talk group, that is, the message talk contents of the talk group “X Company Project Development” at all, it would be inconvenient. If the user D is not able to learn about the message talk contents of the derivation source talk group, the user D may not refer to the discussion about the function Y and may not grasp, for example, how he or she has got involved in the talk group and the flow of discussion so far.

In addition, for the users A to C, such troubles do not arise. This is because the users A to C are members of the talk group “X Company Project Development” and are also members of the talk group “Consideration of Implementation of Function Y in X Company Project”.

Thus, the message and group controller 141 of the chat service server 14 or the controller 10A2 of the user terminal A makes it possible to create the derivative talk group based on the derivation source talk group and gives the user D who is newly added to the derivative talk group access authority to access a predetermined range of message talks of the derivation source talk group, thereby providing the security for the derivation source talk group and the convenience of viewing the derivation source talk group.

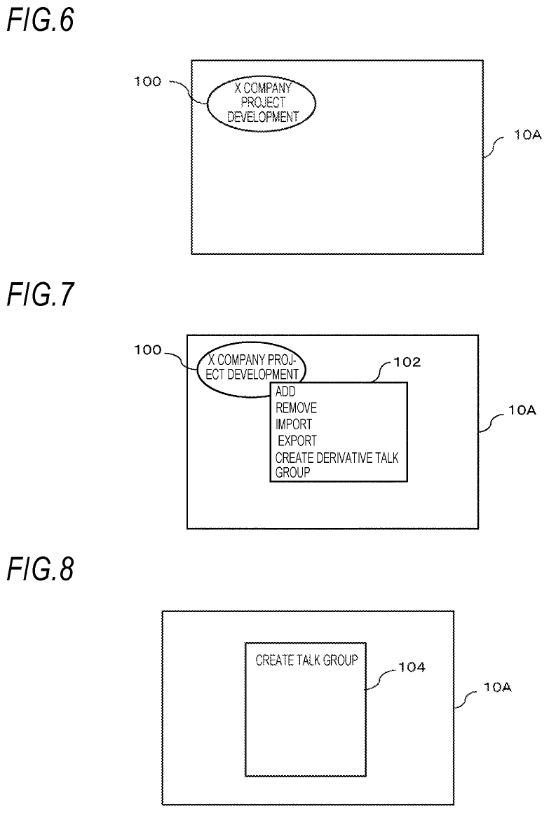

FIG. 6 illustrates an example of a screen displayed on the display unit 10A3 of the user terminal A (10A). A talk group list screen is displayed on the display unit 10A3 of the user terminal A in response to an operation by the user A. This screen is displayed, for example, when the Web client software installed in the user terminal A requests the chat service server 14 for the screen and receives the talk group list screen about the user A created by the chat service server 14 from the chat service server 14. In response to the request from the Web client software of the user terminal A, the message and group controller 141 of the chat service server 14 refers to the user information storage unit 142 and the group information storage unit 143, and reads out information about talk groups to which the user A belongs to create the talk group list screen about the user A.

It is assumed that the talk group “X Company Project Development” exists and the users A to C are members thereof. The chat service server 14 creates a list screen including the talk group “X Company Project Development” as a talk group including the user A as a member. The controller 10A2 of the user terminal A receives the talk group list screen created by the chat service server 14 and displays the screen on the display unit 10A3. Thereby, as illustrated in FIG. 6, only a talk group “X Company Project Development” 100 is displayed on the display unit 10A3 of the user terminal A.

FIG. 7 illustrates a state where the controller 10A2 displays a menu 102 on the display unit 10A3, for example, when the user A performs an operation to right click a mouse in the state of FIG. 6. In addition, the right-click operation is an example of a user operation. The present disclosure is not limited to this example. A touch operation, a tap operation, or a voice input operation may be performed instead. In the menu 102, respective items as listed below are displayed.
Add
Remove
Import
Export
Create Derivative Talk Group
   “Create Derivative Talk Group” indicates creating a new talk group by deriving the new talk group from the talk group “X Company Project Development”. When the user A selects “Derivative Talk Group Creation” by, for example, clicking on, the controller 10A2 displays on the display unit 10A3 a talk group creation screen for creation of the derivative talk group. The controller 10A2 of the user terminal A executes the Web client software to request the chat service server 14 to create a talk group based on the derivation source talk group “X Company Project Development”. In response to this request, the message and group controller 141 of the chat service server 14 reads out information on the talk group “X Company Project Development” stored in the group information storage unit 143, creates a talk group creation screen, and sends back the created talk group creation screen to the user terminal A. The controller 10A2 of the user terminal A receives the talk group creation screen via the communication unit 10A1 and displays the talk group creation screen on the display unit 10A3.

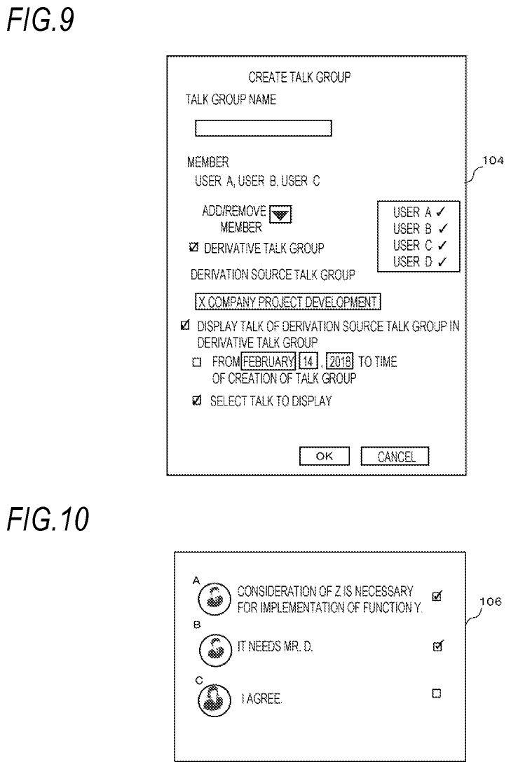

FIG. 8 illustrates a talk group creation screen 104 for creation of a derivative talk group. FIG. 9 illustrates a detailed screen of the talk group creation screen 104. FIG. 9 illustrates items of the derivative talk group creation screen 104 as listed below.
Talk Group Name
Members
Add/Remove Member
Derivation Source Talk Group
Display Talks of Derivation Source Talk Group in Derivative Talk Group
Select Talks to Display

“Talk Group Name” is the name of the derivative talk group. The user A inputs a desired name of the derivative talk group in an input field. For example, the user A inputs “Consideration of Implementation of Function Y in X Company Project”.

For “member”, the members of the derivation source talk group are displayed as they are. Since the members of the derivation source talk group “X Company Project Development” are the users A to C, the names of the users A to C are displayed.

“Add/Remove Member” is an item to set adding a new user to the derivative talk group from members of the derivation source talk group or removing any member in the derivative talk group. When a pull-down menu is selected, a list of users who have authorization to use the chat service server 14 is displayed, and check marks are displayed for the users of the derivation source talk group. When adding a new user, the user A adds a check mark to a user to be added. FIG. 9 illustrates a case where a check mark is added to the user D in order to newly add the user D. On the other hand, when removing the user C, the check mark of user C is removed.

For “Derivation Source Talk Group”, the name of the derivation source talk group is displayed. The user A may ascertain the derivation source talk group when viewing this name, and may refer to the name when inputting the name of the derivative talk group.

“Display Talk of Derivation Source Talk Group in Derivative Talk Group” is the item to give the user D who is newly added to the derivative talk group access authority to access message talks of the derivation source talk group. In FIG. 9, the following two methods are displayed as a method of giving the access authority.
(1) Message talks within a predetermined period from a time at which the derivative talk group is created.
(2) Individually select message talks to be displayed

Here, the predetermined period may be set in any manner, and a default value is, for example, one week. It is assumed that the time of creation of the derivative talk group is Feb. 21, 2018. In a default state, message talks from Feb. 14, 2018 to Feb. 21, 2018 are set to a display target.

Either one of the above methods (1) and (2) is selected. The user A may select any one method by giving a check mark to a checkbox of the method. FIG. 9 illustrates a case where the method (2) is selected. In this case, the controller 10A2 further displays on the display unit 10A3 a screen that allows to individually select the message talks in the derivation source talk group that the user D may view.

FIG. 10 illustrates a message talk selection screen to give the user D the access authority. The message talk contents of the derivation source talk group are displayed in a list. The user A selects the message talk contents that the user D may view, and adds check marks thereto. More specifically, when the method (2) is selected by the user A, the controller 10A2 of the user terminal A executes the Web client software to request the chat service server 14 for a list of message talks in the derivation source talk group “X Company Project Development”. In response to this request, the message and group controller 141 of the chat service server 14 reads out message talk list data of the talk group “X Company Project Development” stored in the message storage unit 144 and sends back the message talk list data to the user terminal A. The controller 10A2 of the user terminal A receives the message talk list data via the communication unit 10A1 and displays the message talk list data on the display unit 10A3.

It is assumed that the message talk contents in the derivation source talk group “X Company Project Development” is as follows:
User A: Consideration of Z is necessary for implementation of function Y
User B: It needs Mr. D
User C: I agree.

Then, the user A operates the user terminal A to select, from these message talks, two message talks of:
User A: Consideration of Z is necessary for implementation of function Y
User B: It needs Mr. D
   and add check marks to the two message talks. Thereafter, when the user A confirms the selection by operating, for example, an OK button (not illustrated) on the screen, the controller 10A2 of the user terminal A executes the Web client software to transmit information on the selected message talks as the access authority of the user D to the chat service server 14. The message and group controller 141 of the chat service server 14 receives the information on the selected message talks as the access authority of the user D and stores the information as the access authority of the user D in the group information table.

As described above, the access authority to access the predetermined range of the message talks in the derivation source talk group is given to the user D who is newly added to the derivative talk group. The access authority is stored and managed in the group information table of the group information storage unit 143 of the chat service server 14.

In FIG. 6, the derivative talk group is created from the talk group list screen. Instead, the derivative talk group may be created from the talk screen.

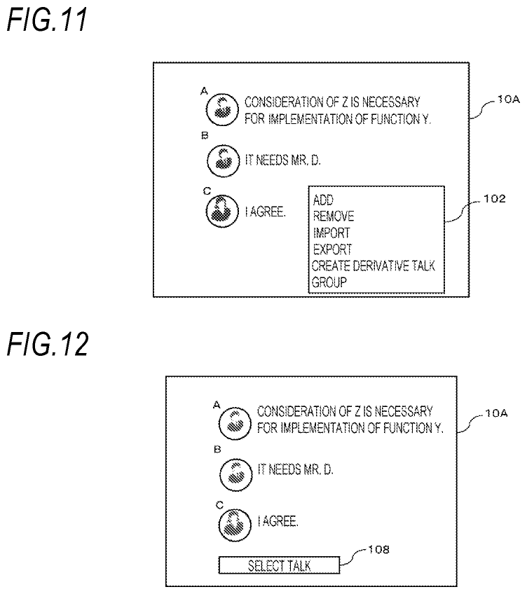

FIG. 11 illustrates another example of a screen displayed on the display unit 10A3 of the user terminal A (10A). A talk screen is displayed on the display unit 10A3 in response to an operation by the user A. This screen is displayed when the Web client software installed in the user terminal A requests the chat service server 14 for the talk screen and receives from the chat service server 14 the talk screen associated with the talk group “X Company Project Development” created by the message and group controller 141 of the chat service server 14. In response to the request from the Web client software of the user terminal A, the message and group controller 141 of the chat service server 14 refers to the user information storage unit 142, the group information storage unit 143, and the message storage unit 144 and reads out the message talks of the talk group “X Company Project Development” to which the user A belongs to thereby create the talk screen.

It is assumed that the message talk contents in the talk group “X Company Project Development” is as follows:
User A: Consideration of Z is necessary for implementation of function Y
User B: It needs Mr. D
User C: I agree.

In this state, when the user A performs, for example, a right-click operation, the controller 10A2 superimposes and displays the menu 102 on the talk screen. In the menu 102, respective items as listed below are displayed.
Add
Remove
Import
Export
Create Derivative Talk Group
   “Create Derivative Talk Group” indicates creating a new talk group by deriving the new talk group from the talk group “X Company Project Development”. When the user A selects “Create Derivative Talk Group” by, for example, clicking on, the controller 10A2 displays a talk group creation screen for creation of the derivative talk group (see FIG. 9) on the display unit 10A3.

That is, the controller 10A2 of the user terminal A executes the Web client software to request the chat service server 14 to create a talk group based on the derivation source talk group “X Company Project Development”. In response to this request, the message and group controller 141 of the chat service server 14 reads out information on the talk group “X Company Project Development” stored in the group information storage unit 143, creates a talk group creation screen, and sends back the created talk group creation screen to the user terminal A. The controller 10A2 of the user terminal A receives the talk group creation screen via the communication unit 10A1 and displays the talk group creation screen on the display unit 10A3.

In the above description, a transition is made from the talk group list screen or the talk screen to the talk group creation screen and viewable message talks of the derivation source talk group in the talk group creation screen are set. Alternatively, other methods are also possible.

FIG. 12 illustrates a further example of a screen displayed on the display unit 10A3 of the user terminal A (10A). In response to an operation by the user A, a talk screen is displayed on the display unit 10A3 of the user terminal A as in FIG. 11. On the talk screen, a “Select Talk” button 108 is displayed at the bottom of the screen together with the message talk contents. By operating the button 108, it is possible to select a talk that a user who is newly added to the derivative talk group may view. In other words, instead of giving access authority to a new user after creation of the derivative talk group, the derivative talk group may be created after giving the access authority.

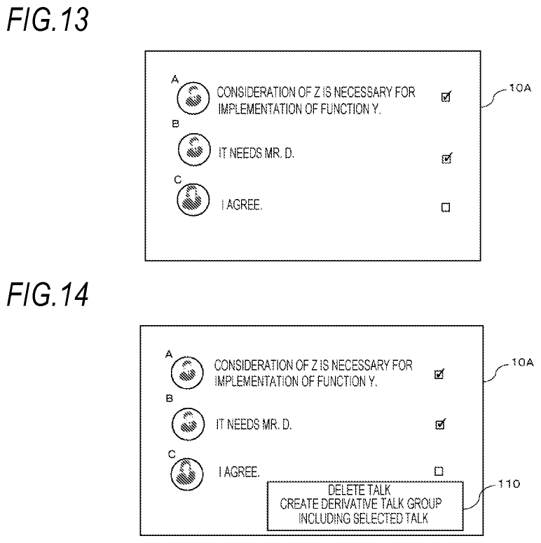

FIG. 13 illustrates an example of a screen when the button 108 is operated in the state of FIG. 12. The screen for selection of a talk is displayed as in FIG. 10. The user A sets a message talk that a user who is newly added to the derivative talk group to be created from now may view.

FIG. 14 illustrates a screen in a case where the user A performs a right-click operation, for example, in the state of FIG. 13. The controller 10A2 superimposes and displays a menu 110 in response to the operation by the user A. In the menu 110, respective items as listed below are displayed.
Delete Talk
Create Derivative Talk Group Including Selected Talk
   When creating the derivative talk group, the user A selects the item “Create Derivative Talk Group Including Selected Talk”.

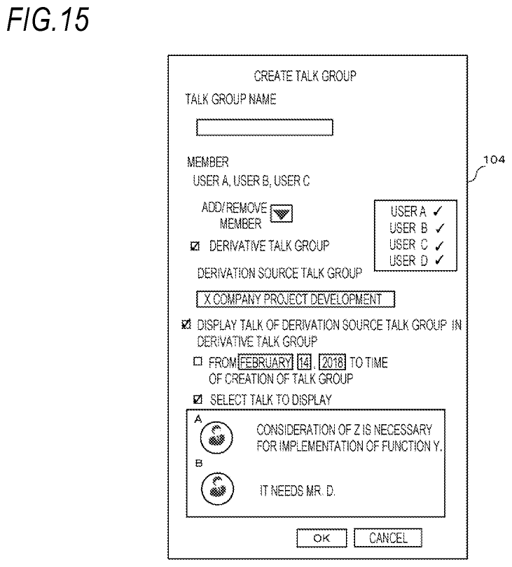

FIG. 15 illustrates an example of a screen in a case where the item “Create Derivative Talk Group Including Selected talk” is selected in the state of FIG. 14. The talk group creation screen 104 is similar to that in FIG. 9, but is different from FIG. 9 in that the previously selected message talks are displayed in the item “Select Talk to Display”. When viewing this screen, the user A may easily ascertain the range of the access authority of the user D who is newly added to the derivative talk group.

When the derivative talk group “Consideration of Implementation of Function Y in X Company Project” is created based on the derivation source talk group “X Company Project Development”, information on the derivative talk group “Consideration of Implementation of Function Y in X Company Project”, that is, information on the derivation source talk group and information on the users of the derivative talk group are stored in the group information storage unit 143 of the chat service server 14. The information on the users of the derivative talk group includes, in addition to the IDs of the users forming the derivative talk group, information on the access authority of a user who is newly added to the derivative talk group but is not a member of the derivation source talk group (here, the user D). Specifically, the information on the users of the derivative talk group includes information on message talks that may be viewed in the derivation source talk group.

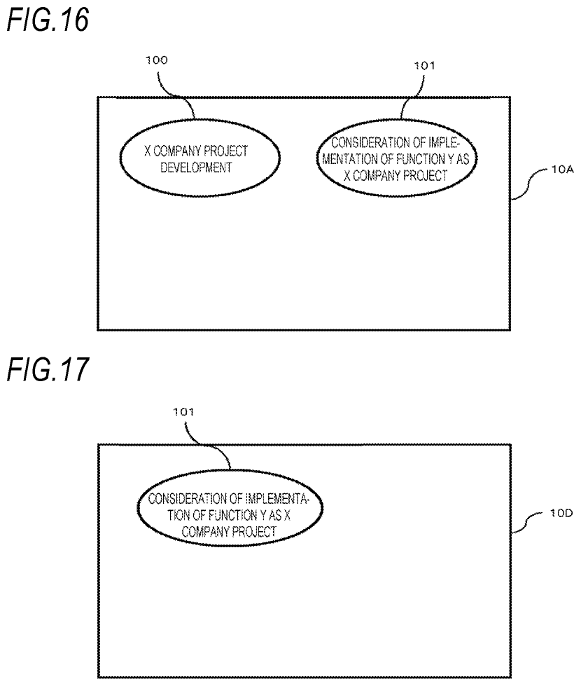

FIG. 16 illustrates an example of a talk group list screen displayed on the display unit 10A3 of the user terminal A after creating the talk group “Consideration of Implementation of Function Y in X Company Project” based on the talk group “X Company Project Development”. In addition to the derivation source talk group “X Company Project Development” 100, a derivative talk group “Consideration of Implementation of Function Y in X Company Project” 101 is newly displayed. In FIG. 16, the derivation source talk group “X Company Project Development” 100 and the derivative talk group “Consideration of Implementation of Function Y in X Company Project” 101 are displayed in parallel. Alternatively, the derivation source talk group “X Company Project Development” 100 and the derivative talk group “Consideration of Implementation of Function Y in X Company Project” 101 may be displayed in a hierarchical structure so that a relationship between the derivation source and the derivative may be seen.

FIG. 17 illustrates an example of the talk group list screen displayed on the display unit of the user terminal D (10D) after creating the talk group “Consideration of Implementation of Function Y in X Company Project” based on the talk group “X Company Project Development”. Since the user D is not a member of the derivation source talk group “X Company Project Development”, the derivation source talk group “X Company Project Development” 100 is not displayed and only the derivative talk group “Consideration of Implementation of Function Y in X Company Project” 101 is displayed. The derivation source talk group “X Company Project Development” 100 may be grayed out, or the derivation source talk group “X Company Project Development” 100 may be grayed out and displayed in a hierarchical structure so that the relationship between the derivation source and the derivative may be seen.

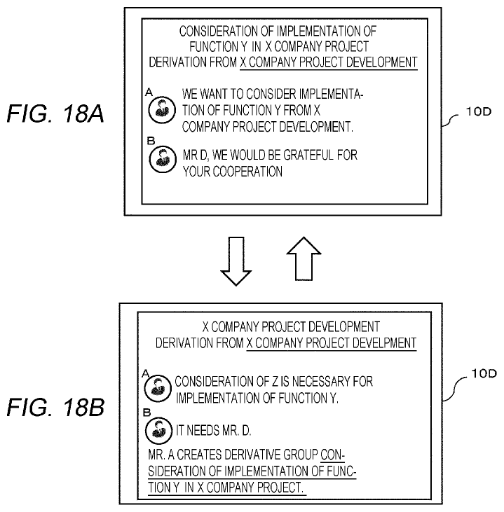

FIGS. 18A and 18B illustrate examples of talk screens displayed on the display unit of the user terminal D (10D). FIG. 18A is a talk screen displayed, for example, when the user D selects the derivative talk group “Consideration of Implementation of Function Y in X Company Project” 101 in FIG. 17 by clicking on it. The talk group name “Consideration of Implementation of Function Y in X Company Project” is displayed and the fact that the talk group is derived from the talk group “X Company Project Development” is displayed. Then, message talks in this talk group are displayed from top to bottom in the chronological order under the header item.

Here, a link (indicated by an underline) is provided at the derivation source talk group “X Company Project Development”. When the user D clicks on this link, for example, a transition to the talk screen of the talk group “X Company Project Development” is made. For example, the user D who views the message talk contents of the derivative talk group “Consideration of Implementation of Function Y in X Company Project” may want to know how he or she has got involved in this talk group or the discussion about the function Y up until that time. In such a case, the user D makes a transition to the talk screen of the talk group “X Company Project Development” by clicking on the link. The message talks that the user D may view on the talk screen of the talk group “X Company Project Development” are limited to the predetermined range set by the user A, for example, in FIGS. 9, 10, and 13 to 15.

FIG. 18B illustrates an example of a screen displayed when the user D clicks on the derivation source talk group “X Company Project Development” in the state of FIG. 18A. Among the message talks included in the derivation source talk group “X Company Project Development”, only the message talks within the access authority of the user D set by the user A, that is,
User A: Consideration of Z is necessary for implementation of function Y
User B: It needs Mr. D
   are displayed and the other message talks are not displayed and may not be viewed.

In addition, at the bottom of this talk screen, it is displayed that the derivative talk group “Consideration of Implementation of Function Y in X Company Project” is created by the user A. A link (indicated by an underline) is provided at the derivative talk group “Consideration of Implementation of Function Y in X Company Project”. When the user D clicks on the link, for example, a transition to the talk screen of the derivative talk group “Consideration of Implementation of Function Y as X Company Project” is again made. That is, a transition from the screen of FIG. 18A to the screen of FIG. 18B may be made by single click, and a transition from the screen of FIG. 18B to the screen of FIG. 18A may be made by single click.

More detailed description will be given below.

When creating the talk screen of the derivative talk group “Consideration of Implementation of Function Y as X Company Project”, the message and group controller 141 of the chat service server 14 creates the talk screen illustrated in FIG. 18A by referring to the group information table of the group information storage unit 143 to specify the derivation source talk group “X Company Project Development” and creating a link to access the derivation source talk group “X Company Project Development”, and sends back the created talk screen to the user terminal D. When the user D clicks on the link, for example, an operation signal is transmitted from the user terminal D to the chat service server 14, and the message and group controller 141 of the chat service server 14 refers to the group information table of the group information storage unit 143 and reads out the message talks of the derivation source talk group “X Company Project Development” within the range of the access authority set for the user D from the message storage unit 144, to thereby create the talk screen. At this time, the message and group controller 141 creates a link to access the derivative talk group “Consideration of Implementation of Function Y in X Company Project” to thereby create the talk screen illustrated in FIG. 18B, and sends back the created talk screen to the user terminal D. When the user D clicks on the link, for example, the operation signal is transmitted from the user terminal D to the chat service server 14, and the message and group controller 141 of the chat service server 14 again sends back the talk screen “Consideration of Implementation of Function Y as X Company Project” to the user terminal D.

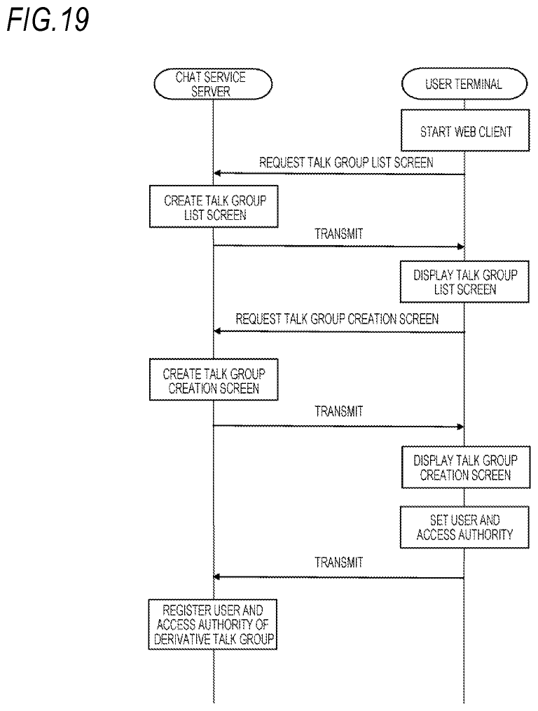

FIG. 19 illustrates a sequence diagram in a case where the chat service server 14 serves as an information processing apparatus.

The Web client software installed in the user terminal A (or another user terminal) is started, and the chat service server 14 receives a request for a talk group list screen in response to an operation by the user A.

In response to the request from the user terminal A, the message and group controller 141 of the chat service server 14 creates the talk group list screen and sends back the created talk group list screen to the user terminal A. That is, the message and group controller 141 accesses the user information storage unit 142 and the group information storage unit 143 and reads out information on the talk group including the user A as a member, that is, the talk group name and the user names of the members, to thereby create the talk group list screen. The message and group controller 141 sends back the created talk group list screen to the user terminal A.

The user terminal A receives the talk group list screen from the chat service server 14 and displays the screen on the display unit 10A3. Then, the user terminal A requests the chat service server 14 for a talk group creation screen in response to an operation by the user A.

In response to the request from the user terminal A, the message and group controller 141 of the chat service server 14 creates the talk group creation screen and sends back the created talk group creation screen to the user terminal A. That is, the message and group controller 141 accesses the user information storage unit 142 and the group information storage unit 143 and reads out the name of the derivation source talk group and the user names of the members, to thereby create the talk group creation screen. The message and group controller 141 sends back the created talk group creation screen to the user terminal A.

The user terminal A receives the talk group creation screen from the chat service server 14 and displays the received talk group creation screen on the display unit 10A3. Then, in response to an operation by the user A, the name of the derivative talk group, the user names of the members, and information on the access authority of a user who is newly added are transmitted to the chat service server 14.

The message and group controller 141 of the chat service server 14 receives the name of the derivative talk group, the user names of the members, and the information on the access authority of the newly added user (user D) transmitted from the user terminal A, and newly stores and registers the received information in the group information table of the group information storage unit 143.

Thereafter, in response to a request from the user terminal D, the message and group controller 141 creates a talk screen of the derivative talk group and sends back the created talk screen to the user terminal D. At this time, the message and group controller 141 creates and adds a link to the derivation source talk group. In addition, when receiving a request for the derivation source talk group from the user terminal D, the message and group controller 141 creates a talk screen of the derivation source talk group and transmits the talk screen to the user terminal D, and reads out the access authority given to the user D from the group information table and displays only the message talks that the user D is permitted to view.

In addition, in response to a request from the user terminal A, the chat service server 14 may create a talk screen instead of the talk group list screen and send back the talk screen to the user terminal A, and may create a talk group creation screen from the talk screen and send back the created talk group creation screen the user terminal A.

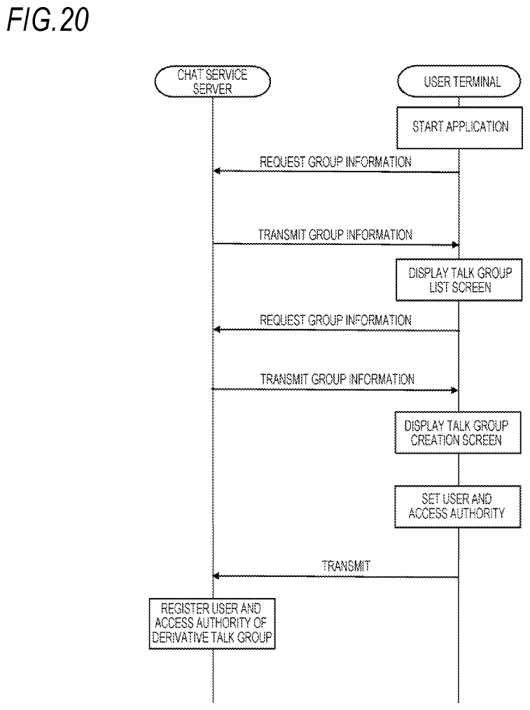

FIG. 20 illustrates a sequence diagram in a case where the user terminal A (or another terminal) serves as an information processing apparatus.

The controller 10A2 of the user terminal A (or another user terminal) starts an application program and requests the chat service server 14 for group information in response to an operation by the user A.

In response to the request from the user terminal A, the message and group controller 141 of the chat service server 14 accesses the user information storage unit 142 and the group information storage unit 143 and reads out information on the talk group including the user A as a member, that is, the talk group name and the user names of the members and sends back the read information to the user terminal A.

The controller 10A2 of the user terminal A receives the group information from the chat service server 14, creates a talk group list screen using the group information, and displays the created talk group list screen on the display unit 10A3. Then, the user terminal A requests the chat service server 14 for a talk group creation screen in response to an operation by the user A.

In response to the request from the user terminal A, the message and group controller 141 of the chat service server 14 reads out the name of the derivation source talk group and the user names of the members and sends back the read information to the user terminal A.

The controller 10A2 of the user terminal A receives the information from the chat service server 14, creates the talk group creation screen using the information, and displays the created talk group creation screen on the display unit 10A3. Then, in response to an operation by the user A, the name of the derivative talk group, the user names of the members, and information on the access authority of a user who is newly added are transmitted to the chat service server 14.

The message and group controller 141 of the chat service server 14 receives the name of the derivative talk group, the user names of the members, and the information on the access authority of the newly added user (user D) transmitted from the user terminal A, and newly stores and registers the received information in the group information table of the group information storage unit 143. Thereafter, the message and group controller 141 sends back the message talks of the derivative talk group to the user terminal D in response to a request from the user terminal D. The user terminal D creates and displays a talk screen using these message talks. At this time, a link to the derivation source talk group is created and added. In addition, when receiving a request for the derivation source talk group from the user terminal D, the message and group controller 141 reads out the access authority given to the user D from the group information table and transmits only the message talks that the user D is permitted to view. The user terminal D displays only the message talks that the user D is permitted to view.

The exemplary embodiment of the present disclosure is described above. It should be noted that the present disclosure is not limited to this exemplary embodiment. Various modifications may be made. Hereinafter, modifications will be described.

### <Modification 1>

In the exemplary embodiment, the user D is newly added to the derivative talk group, and the access of the user D is limited to the predetermined range of the derivation source talk group. Two or more new users may be added to the derivative talk group. In this case, access authority to access different ranges may be given to the respective newly added users. For example, a new user D and a new user E may be added to the derivative talk group. The user D may be permitted to view message talks within one week from the creation date of the derivative talk group among the message talks of the derivative source talk group. The user E may be permitted to view message talks within two weeks from the creation date of the derivation source talk group.

### <Modification 2>

In the exemplary embodiment, as the access authority to access the predetermined range, the message talks within a predetermined period on the basis of the creation time of the derivative talk group are set. It should be noted that the present disclosure is not limited to this example. The predetermined number of message talks on the basis of the creation time of the derivative talk group may be set. For example, eight message talks before the creation time of the derivative talk group may be set.

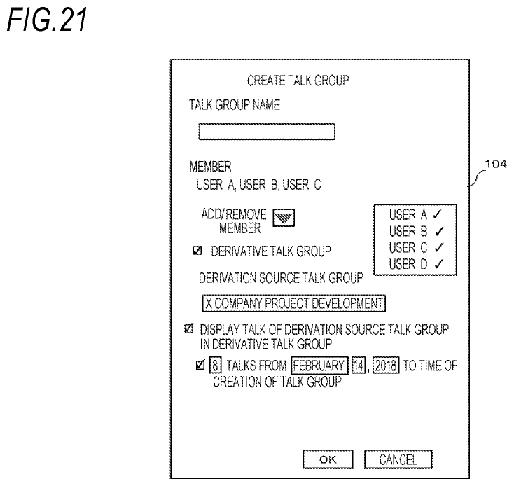

FIG. 21 illustrates a talk group creation screen in this case. This modification is different from FIG. 9 in that the number of message talks may be set on the basis of the creation time of the derivative talk group (Feb. 14, 2018 in FIG. 21). When the number of message talks is set to eight as illustrated in FIG. 21, a newly added user is permitted to view only eight message talks.

### <Modification 3>

In the exemplary embodiment, as the access authority to access the predetermined range, the talks within the predetermined period on the basis of the creation time of the derivative talk group are set. It should be noted that the present disclosure is not limited to this example. Among the message talks before the creation time of the derivative talk group, only message talks of a specific user may be set. For example, only the message talks of the user A or only the message talks of the user B may be set.

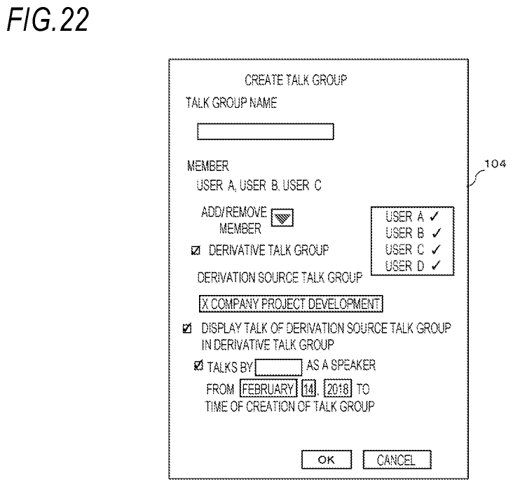

FIG. 22 illustrates a talk group creation screen in this case. This modification is different from FIG. 9 in that a user name of a speaker may be set on the basis of the creation time of the derivative talk group (Feb. 14, 2018 in FIG. 22).

### <Modification 4>

In the exemplary embodiment, as the access authority to access the predetermined range, the talks within a predetermined period on the basis of the creation time of the derivative talk group are set. It should be noted that the present disclosure is not limited to this example. Only message talks including a specific keyword may be set. For example, only message talks including a keyword “function Y” may be set.

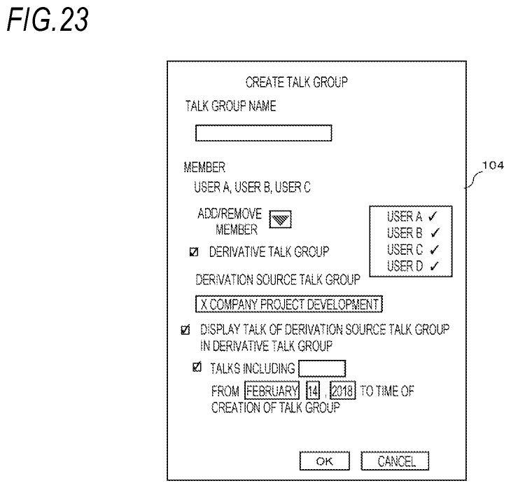

FIG. 23 illustrates a talk group creation screen in this case. This modification is different from FIG. 9 in that message talks including a specific keyword may be set on the basis of the creation time of the derivative talk group (Feb. 14, 2018 in FIG. 23).

### <Modification 5>

In the exemplary embodiment, as the access authority to access the predetermined range, the talks within the predetermined period on the basis of the creation time of the derivative talk group are set. It should be noted that the present disclosure is not limited to this example. Only message talks related to a specific topic may be set. For example, when the user B responds to a talk of the user A about a specific topic and the user C responds to this talk of the user B, the series of talks may be set to the talks related to the specific topic.

### <Modification 6>

In the exemplary embodiment, viewing the talks of the derivation source talk group is described as the access authority to access the predetermined range. Alternatively, the access authority may allow an operation other than viewing, for example, transmission to the derivation source talk group. If it is not desirable that a user other than users who are members of the derivation source talk group posts a message talk, the access authority may allow only viewing.

### <Modification 7>

In the exemplary embodiment, as illustrated in FIGS. 18A and 18B, when the user D accesses the derivation source talk group, only the talks within the range set by the user A may be displayed and viewed. When the user D wants to view the talks beyond this range, the user D may transmit a request to view the talks to the user A and a range within which the user A gives the access authority in response to this request may be expanded (changed). For example, on the screen of FIG. 18B, a button “Request to View Other Talks” is displayed at the bottom of the talk screen. When the user D clicks on this button with a mouse, the request is transmitted to the chat service server 14, and the chat service server 14 further transmits the request to the user terminal A. The user A operates the user terminal A to display the screen of FIG. 9 again, and gives new access authority by changing the range within which the user A gives the access authority to the user D on this screen.

For example, while the original access authority allows the user D to view the message talks within one week from the creation date of the derivative talk group, the user A changes the access authority so as to allow the user D to view message talks within two weeks from the creation date of the derivative talk group. Alternatively, while the original access authority allows the user D to view eight message talks, the user A changes the access authority so as to allow the user D to view, for example, twenty message talks.

When the range of the access authority given to the user D is changed, the chat service server 14 may notify to that effect to users other than the user A, specifically, to the user B and the user C of the derivation source talk group.

Also, when there is a special circumstance in which it is unnecessary to limit the range that the user D who is newly added to the derivative talk group accesses, the limitation to the predetermined range may be cancelled to allow the user D to access all of the message talks of the derivation source talk group. For example, on the screen of FIG. 9, an item “Allow All Talks” may be added to allow the user D to access all message talks when the user A checks this item.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a creator configured to create a second talk group based on a first talk group on a service on which massage talks are exchanged between a plurality of users, the first talk group consisting of a first user group, the second talk group consisting of a second user group including one or more users of the first user group, the second user group being different from the first user group; and
a granting unit configured to, when the second talk group is created, give to users of the second user group, access authority to access a predetermined range of message talks in the first talk group.

2. The information processing apparatus according to claim 1, wherein the granting unit gives the access authority to access the predetermined range to a user who is not included in the first user group, among the users of the second user group.

3. The information processing apparatus according to claim 1, wherein the granting unit selects a message talk in the first talk group that is accessible by the users of the second user group.

4. The information processing apparatus according to claim 3, wherein the message talk in the first talk group accessible by the users of the second user group is a message talk within a predetermined period from a time point at which the second talk group is created.

5. The information processing apparatus according to claim 3, wherein the message talk in the first talk group accessible by the users of the second user group is the predetermined number of message talks from a time point at which the second talk group is created.

6. The information processing apparatus according to claim 3, wherein the message talk in the first talk group accessible by the users of the second user group is a message talk of a specific user.

7. The information processing apparatus according to claim 3, wherein the message talk in the first talk group accessible by the users of the second user group is a message talk including a specific keyword.

8. The information processing apparatus according to claim 3, wherein the message talk in the first talk group accessible by the users of the second user group is a message talk related to a specific topic.

9. The information processing apparatus according to claim 3, wherein the creator creates the second talk group during exchange of the message talks in the first talk group.

10. The information processing apparatus according to claim 1, wherein the granting unit gives the access authority to access the predetermined range of the message talks in the first talk group to the users of the second user group after the second talk group is created.

11. The information processing apparatus according to claim 1, wherein the granting unit gives the access authority to access the predetermined range of the message talks in the first talk group before the second talk group is created.

12. The information processing apparatus according to claim 1, further comprising:
a request unit configured to allow the users of the second user group to request the users of the first user group for access authority to access a range beyond the predetermined range.

13. The information processing apparatus according to claim 12, wherein the granting unit gives new access authority to access the message talks in the first talk group in response to the request from the request unit.

14. The information processing apparatus according to claim 13, further comprising:
a notification unit configured to notify, to the users of the first user group, that the new access authority to access the message talks in the first talk group is given in response to the request from the request unit.

15. The information processing apparatus according to claim 1, wherein the access authority includes authority to view the message talks in the first talk group.

16. The information processing apparatus according to claim 1, wherein
the access authority includes authority to view the message talks of the first talk group, and
the access authority does not include authority to transmit a message talk in the first talk group.

17. A non-transitory computer readable medium storing a program that causes a computer to execute information processing, the information processing comprising:
creating a second talk group based on a first talk group on a service on which massage talks are exchanged between a plurality of users, the first talk group consisting of a first user group, the second talk group consisting of a second user group including one or more users of the first user group, the second user group being different from the first user group; and
when the second talk group is created, giving to users of the second user group, access authority to access a predetermined range of message talks in the first talk group.

18. An information processing apparatus comprising:
means for creating a second talk group based on a first talk group on a service on which massage talks are exchanged between a plurality of users, the first talk group consisting of a first user group, the second talk group consisting of a second user group including one or more users of the first user group, the second user group being different from the first user group; and
means for, when the second talk group is created, giving to users of the second user group, access authority to access a predetermined range of message talks in the first talk group.
